(19) United States
(12) Patent Application Publication
(10) Pub. No.: US 2022/0197586 A1
(43) Pub. Date: Jun. 23, 2022

(54) METHOD FOR OPERATING COMMUNICATION APPARATUS, AND COMMUNICATION APPARATUS

(71) Applicant: SEIKO EPSON CORPORATION, Tokyo (JP)

(72) Inventor: Katsuyoshi YAMAGUCHI, Matsumoto-shi (JP)

(73) Assignee: SEIKO EPSON CORPORATION, Tokyo (JP)

(21) Appl. No.: 17/558,109

(22) Filed: Dec. 21, 2021

(30) Foreign Application Priority Data
Dec. 22, 2020 (JP) 2020-212148

(51) Int. Cl. G06F 3/14; G06F 3/147; H04N 9/31

(52) U.S. Cl. CPC G06F 3/1454; H04N 9/3179; G06F 3/147

(57) ABSTRACT

A method for operating a communication apparatus, the method comprising: establishing connection, in response to establishment of connection between the communication apparatus and an information processing apparatus, between the communication apparatus and a display apparatus that displays a first image on a display surface; causing the communication apparatus to acquire from the display apparatus first information representing a maximum number of one or more image signals used to generate the first image and second information representing a number of image signals being received by the display apparatus from one or more other information processing apparatuses different from the information processing apparatus in response to the establishment of the connection between the communication apparatus and the display apparatus; and causing the communication apparatus to cause the information processing apparatus to display a second image based on the first information and the second information.

The present application is based on, and claims priority from JP Application Serial Number 2020-212148, filed Dec. 22, 2020, the disclosure of which is hereby incorporated by reference herein in its entirety.

### BACKGROUND

### 1. Technical Field

The present disclosure relates to a method for operating a communication apparatus and to a communication apparatus.

### 2. Related Art

JP-A-2012-32508 discloses a terminal apparatus capable of providing a display apparatus with an image signal. A user operates the terminal apparatus to cause the terminal apparatus to search for a projector. The user subsequently performs an operation on the terminal apparatus to select a connection destination projector to which the terminal apparatus is connected from a list showing the result of the search for a projector. The terminal apparatus is connected to the connection destination projector in response to the operation. When connected to the connection destination projector, the terminal apparatus acquires from the connection destination projector information on an image to be projected by the connection destination projector.

To obtain information on an image to be displayed by a display apparatus, such as a projector, by using the technology disclosed in JP-A-2012-32508, the user needs to perform an operation of searching for display apparatuses, such as projectors, and an operation of selecting a display apparatus, such as a connection destination projector.

### SUMMARY

One aspect of a method for operating a communication apparatus according to the present disclosure includes establishing connection between the communication apparatus and a display apparatus in response to establishment of connection between the communication apparatus and an information processing apparatus, acquiring from the display apparatus first information representing a maximum number of images that can be contained in a first image displayed by the display apparatus on a display surface and second information representing the number of image signals being received by the display apparatus in response to the establishment of the connection between the communication apparatus and the display apparatus, and causing the information processing apparatus to display a second image based on the first information and the second information, and the number of images that can be contained in the first image is equal to the number of image signals being received by the display apparatus.

One aspect of a method for operating a communication apparatus according to the present disclosure includes establishing connection between the communication apparatus and a display apparatus when connection between the communication apparatus and an information processing apparatus is established, acquiring from the display apparatus first information representing a maximum number of image signals receivable by the display apparatus and second information representing the number of image signals being received by the display apparatus in response to the establishment of the connection between the communication apparatus and the display apparatus, and causing the information processing apparatus to display a second image based on the first information and the second information.

One aspect of a communication apparatus according to the present disclosure includes a connection controller that establishes connection between the communication apparatus and a display apparatus in response to establishment of connection between the communication apparatus and an information processing apparatus, an acquisition section that acquires from the display apparatus first information representing a maximum number of images that can be contained in a first image displayed by the display apparatus on a display surface and second information representing the number of image signals being received by the display apparatus in response to the establishment of the connection between the communication apparatus and the display apparatus, and a display controller that causes the information processing apparatus to display a second image based on the first information and the second information, and the number of images that can be contained in the first image is equal to the number of image signals being received by the display apparatus.

One aspect of a communication apparatus according to the present disclosure includes a connection controller that establishes connection between the communication apparatus and a display apparatus when connection between the communication apparatus and an information processing apparatus is established, an acquisition section that acquires from the display apparatus first information representing a maximum number of image signals receivable by the display apparatus and second information representing the number of image signals being received by the display apparatus in response to the establishment of the connection between the communication apparatus and the display apparatus, and a display controller that causes the information processing apparatus to display a second image based on the first information and the second information.

### BRIEF DESCRIPTION OF THE DRAWINGS

FIG. 1 shows an example of a display system.

FIG. 2 shows an example of a first information processing apparatus.

FIG. 3 shows an example of a first communication apparatus.

FIG. 4 shows an example of a projector.

FIG. 5 is a flowchart for describing the action of the first communication apparatus.

FIG. 6 shows an example of the aspect of a GUI.

FIG. 7 shows another example of the aspect of the GUI.

FIG. 8 shows another example of the aspect of the GUI.

FIG. 9 shows another example of the aspect of the GUI.

### DESCRIPTION OF EXEMPLARY EMBODIMENTS

### A: First Embodiment

### A1: Overview of Display System 1000

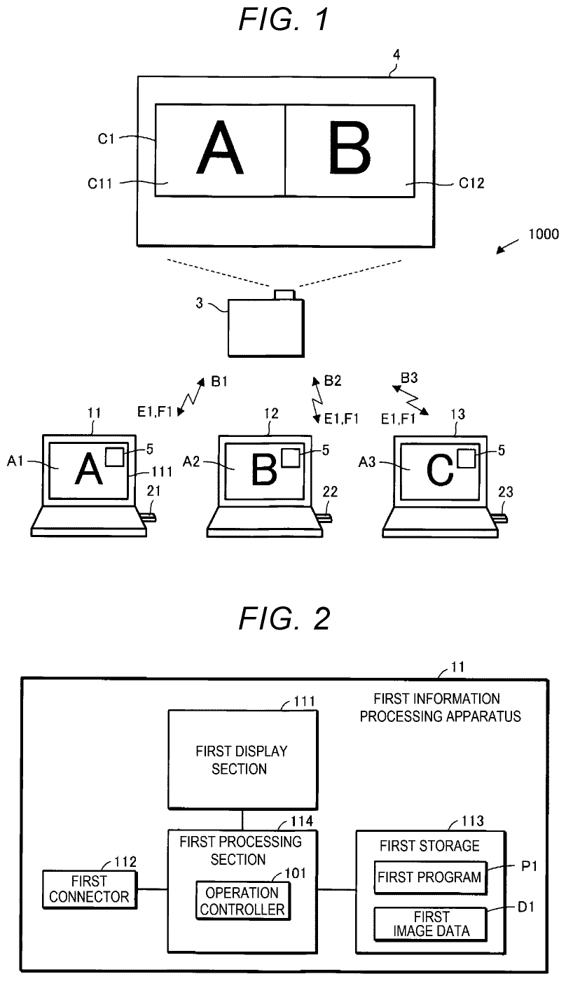

FIG. 1 shows an example of a display system 1000. The display system 1000 includes a first information processing apparatus 11, a second information processing apparatus 12, a third information processing apparatus 13, a first communication apparatus 21, a second communication apparatus 22, a third communication apparatus 23, and a projector 3.

The first information processing apparatus 11 to the third information processing apparatus 13 are each a personal computer (PC). The first information processing apparatus 11 to the third information processing apparatus 13 are each not limited to a PC and may, for example, each be a tablet PC, a smartphone, a document camera, or a video call (VC) terminal. When it is not necessary to distinguish the first information processing apparatus 11 to the third information processing apparatus 13 from each other, the first information processing apparatus 11 to the third information processing apparatus 13 are each referred to as an “information processing apparatus 1”. The number of information processing apparatuses 1 is not limited to “three” and can be changed as appropriate.

The first information processing apparatus 11 outputs an image signal B1 representing an image A1. The image A1 is not limited to the image of “A” shown in FIG. 1 and can be changed as appropriate. The first information processing apparatus 11 is an example of an information processing apparatus.

The second information processing apparatus 12 outputs an image signal B2 representing an image A2. The image A2 is not limited to the image of “B” shown in FIG. 1 and can be changed as appropriate. The second information processing apparatus 12 is another example of the information processing apparatus.

The third information processing apparatus 13 outputs an image signal B3 representing an image A3. The image A3 is not limited to the image of “C” shown in FIG. 1 and can be changed as appropriate. The third information processing apparatus 13 is another example of the information processing apparatus.

The first communication apparatus 21 to the third communication apparatus 23 are each a dongle. Each of the first communication apparatus 21 to the third communication apparatus 23 is not limited to a dongle and may be any instrument having a communication function. When it is not necessary to distinguish the first communication apparatus 21 to the third communication apparatus 23 from each other, the first communication apparatus 21 to the third communication apparatus 23 are each referred to as a “communication apparatus 2”. The number of communication apparatuses 2 is equal to the number of information processing apparatuses 1.

The first communication apparatus 21 is coupled to the first information processing apparatus 11 and connected to the projector 3. The first communication apparatus 21 receives the image signal B1 from the first information processing apparatus 11. The first communication apparatus 21 transmits the image signal B1 to the projector 3. The first communication apparatus 21 is an example of a communication apparatus.

The second communication apparatus 22 is coupled to the second information processing apparatus 12 and connected to the projector 3. The second communication apparatus 22 receives the image signal B2 from the second information processing apparatus 12. The second communication apparatus 22 transmits the image signal B2 to the projector 3. The second communication apparatus 22 is another example of the communication apparatus.

The third communication apparatus 23 is coupled to the third information processing apparatus 13 and connected to the projector 3. The third communication apparatus 23 receives the image signal B3 from the third information processing apparatus 13. The third communication apparatus 23 transmits the image signal B3 to the projector 3. The third communication apparatus 23 is another example of the communication apparatus.

The projector 3 is an example of a display apparatus. The display apparatus is not limited to the projector 3 and may, for example, be a flat panel display (FPD). The FPD is, for example, a liquid crystal display, a plasma display, or an organic electro-luminescence (EL) display. When the display apparatus is a display, such as an FPD, the display screen of the display is an example of a display surface.

The projector 3 can receive a plurality of image signals in parallel. The maximum number of image signals receivable by the projector 3 is “two”. The maximum number of image signals receivable by the projector 3 means the maximum number of image signals receivable in parallel by the projector 3. The maximum number of image signals receivable by the projector 3 is referred to as a “maximum signal number”. The maximum signal number is not limited to two and may be three or more.

When the number of image signals received by the projector 3 is smaller than the maximum signal number, the projector 3 can newly receive an image signal. The number of image signals received by the projector 3 means the number of image signals actually being received by the projector 3. When the number of image signals received by the projector 3 is equal to the maximum signal number, the projector 3 cannot newly receive an image signal.

The projector 3 displays an overall image C1 on a display surface 4 by projecting the overall image C1 onto the display surface 4. The overall image C1 may contain a plurality of images. The overall image C1 is an example of a first image. The overall image C1 may also be referred to as divided images or a combined image.

The number of images that the overall image C1 can contain is equal to the number of image signals received by the projector 3. The maximum number of images that the overall image C1 can contain is “two”. The maximum number of images that the overall image C1 can contain is referred to as a “maximum image number”. The maximum image number is equal to the maximum signal number, that is, the maximum number of image signals receivable by the projector 3. The maximum image number is not limited to two and may be three or more as long as the maximum image number is equal to the maximum signal number.

The overall image C1 contains a first area C11 and a second area C12. The first area C11 and the second area C12 are horizontally arranged. The first area C11 and the second area C12 may instead be vertically arranged. The first area C11 and the second area C12 are an example of a plurality of areas. The plurality of areas may be arranged in a matrix. The number of plurality of areas contained in the overall image C1 is equal to the maximum image number. The image A1 based on the image signal B1 is shown in the first area C11. The image A2 based on the image signal B2 is shown in the second area C12. The image A2 may be displayed in the first area C11, and the image A1 may be displayed in the second area C12.

The display surface 4 is a screen. The display surface 4 is not limited to a screen and may, for example, be a whiteboard, a wall, a ceiling, a floor, or a door.

### A2: First Information Processing Apparatus 11

FIG. 2 shows an example of the first information processing apparatus 11. The first information processing apparatus 11 includes a first display section 111, a first connector 112, a first storage 113, and a first processing section 114.

The first display section 111 is a display. The first display section 111 is, for example, a liquid crystal display. The first display section 111 is not limited to a liquid crystal display and may, for example, be a plasma display or an organic EL display.

The first connector 112 is a USB (universal serial bus) connector. The first connector 112 is not limited to a USB connector and can be changed as appropriate.

The first storage 113 is a recording medium readable by the first processing section 114. The first storage 113 includes, for example, a nonvolatile memory and a volatile memory. The nonvolatile memory includes at least one of a ROM (read only memory), an EPROM (erasable programmable read only memory), and an EEPROM (electrically erasable programmable read only memory). The volatile memory includes, for example, a RAM (random access memory).

The first storage 113 stores first image data D1 and a first program P1. The first image data D1 represents the image A1. The first program P1 is, for example, an application program.

The first processing section 114 is formed, for example, of one or more CPUs (central processing units). The one or more CPUs are an example of one or more processors. The CPUs and the processors are each an example of a computer.

The first processing section 114 reads the first program P1 from the first storage 113. The first processing section 114 functions as an operation controller 101 by executing the first program P1.

The operation controller 101 may be achieved by a circuit, such as a DSP (digital signal processor), an ASIC (application specific integrated circuit), a PLD (programmable logic device), and an FPGA (field programmable gate array).

The operation controller 101 controls the action of the first information processing section 11. The operation controller 101 reads the first image data D1 from the first storage 113. The operation controller 101 causes the first display section 111 to display the image A1 based on the first image data D1. The operation controller 101 generates the image signal B1 based on the first image data D1. The operation controller 101 transmits the image signal B1 to the first communication apparatus 21 via the first connector 112.

The operation controller 101 causes the first display section 111 to display a GUI (graphical user interface) 5, as shown in FIG. 1. The operation controller 101 determines the aspect of the GUI 5 based on information provided from the first communication apparatus 21. The GUI 5 is an example of a second image and an example of a graphical user interface.

### A3: Second Information Processing Apparatus 12 and Third Information Processing Apparatus 13

The second information processing apparatus 12 and the third information processing apparatus 13 each include the same components as those provided in the first information processing apparatus 11. The second information processing apparatus 12 or the third information processing apparatus 13 will therefore not be described in detail.

### A4: First Communication Apparatus 21

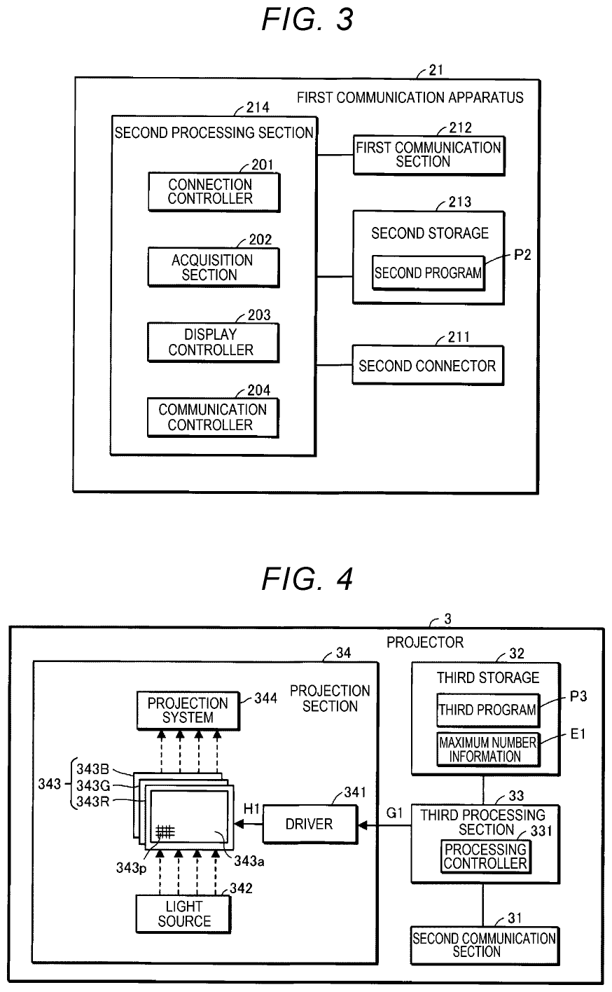

FIG. 3 shows an example of the first communication apparatus 21. The first communication apparatus 21 includes a second connector 211, a first communication section 212, a second storage 213, and a second processing section 214.

The second connector 211 is a USB connector. The second connector 211 can be physically and electrically coupled to the first connector 112 of the first information processing apparatus 11. The second connector 211 is not limited to a USB connector and may be any connector that can be coupled to the first connector 112. The second connector 211 may be connected to the first connector 112, for example, by using a wireless communication scheme, such as near field communication (NFC). In this case, a wireless communication section is used as each of the second connector 211 and the first connector 112.

The first communication section 212 communicates with the projector 3. The first communication section 212 wirelessly communicates with the projector 3 via Wi-Fi. Wi-Fi is an example of a short distance wireless communication scheme. The first communication section 212 may instead wirelessly communicate with the projector 3 by using an infrared communication scheme or Bluetooth in place of Wi-Fi. Bluetooth is a registered trademark. The infrared communication scheme and Bluetooth are other examples of the short distance wireless communication scheme. The scheme of the wireless communication between the first communication section 212 and the projector 3 is not limited to a short distance wireless communication scheme and may instead be another communication scheme.

The second storage 213 is a recording medium readable by the second processing section 214. The second storage 213 includes, for example, a nonvolatile memory and a volatile memory. The second storage 213 stores a second program P2.

The second processing section 214 is formed of one or more CPUs. The second processing section 214 reads the second program P2 from the second storage 213. The second processing section 214 functions as a connection controller 201, an acquisition section 202, a display controller 203, and a communication controller 204 by executing the second program P2. At least one of the connection controller 201, the acquisition section 202, the display controller 203, and the communication controller 204 may be achieved by a circuit, such as a DSP, an ASIC, a PLD, and an FPGA.

The connection controller 201 controls the connection between the first communication apparatus 21 and the first information processing apparatus 11. The connection controller 201, for example, establishes the connection between the first communication apparatus 21 and the first information processing apparatus 11. Establishing the connection between the first communication apparatus 21 and the first information processing apparatus 11 means allowing communication between the first communication apparatus 21 and the first information processing apparatus 11. The connection controller 201 establishes the connection between the first communication apparatus 21 and the first information processing apparatus 11 when the second connector 211 is physically coupled to the first connector 112.

The connection controller 201 further controls connection between the first communication apparatus 21 and the projector 3. The connection controller 201, for example, establishes the connection between the first communication apparatus 21 and projector 3. Establishing the connection between the first communication apparatus 21 and the projector 3 means allowing communication between the first communication apparatus 21 and the projector 3. The connection controller 201 establishes the connection between the first communication apparatus 21 and the projector 3 when the connection between the first communication apparatus 21 and the first information processing apparatus 11 is established.

The acquisition section 202 acquires information from the projector 3. For example, the acquisition section 202 acquires maximum number information E1 and signal number information F1 from the projector 3 in response to the establishment of the connection between the first communication apparatus 21 and the projector 3.

The maximum number information E1 represents the maximum number of images, that is, the maximum number of images that the overall image C1 can contain. The maximum number information E1 is an example of first information representing the maximum number of images that the first image can contain.

The signal number information F1 represents the number of image signals received by the projector 3. The signal number information F1 is an example of second information representing the number of image signals received by the display apparatus.

The display controller 203 controls the display operation performed by the first information processing apparatus 11. For example, the display controller 203 causes the first information processing apparatus 11 to display the GUI 5 by transmitting the maximum number information E1 and the signal number information F1 to the first information processing apparatus 11. The operation controller 101 of the first information processing apparatus 11 determines the aspect of the GUI 5 based on whether the maximum number indicated by the maximum number information E1 is greater than the number indicated by the signal number information F1 or vice versa. The GUI 5 is an image based on whether the maximum number indicated by the maximum number information E1 is greater than the number indicated by the signal number information F1 or vice versa. The GUI 5 is an example of the second image based on the first information and the second information.

The communication controller 204 receives the image signal B1 from the first information processing apparatus 11 via the second connector 211. The communication controller 204 transmits the image signal B1 to the projector 3 via the first communication section 212. For example, when the maximum number indicated by the maximum number information E1 is greater than the number indicated by the signal number information F1, the communication controller 204 transmits the image signal B1 to the projector 3 via the first communication section 212.

### A5: Second Communication Apparatus 22 and Third Communication Apparatus 23

The second communication apparatus 22 and the third communication apparatus 23 each include the same components as those provided in the first communication apparatus 21. The second communication apparatus 22 and the third communication apparatus 23 will therefore not be described in detail.

### A6: Projector 3

FIG. 4 shows an example of the projector 3. The projector 3 includes a second communication section 31, a third storage 32, a third processing section 33, and a projection section 34.

The second communication section 31 wirelessly communicates by using Wi-Fi with each of the first communication apparatus 21 to the third communication apparatus 23. The wireless communication between the second communication section 31 and each of the first communication apparatus 21 to the third communication apparatus 23 does not necessarily use Wi-Fi as described above and may instead use another communication scheme. The second communication section 31 can receive two image signals in parallel at the maximum.

The third storage 32 is a recording medium readable by the third processing section 33. The third storage 32 includes, for example, a nonvolatile memory and a volatile memory. The third storage 32 stores the maximum number information E1 and a third program P3. The maximum number information E1 represents the maximum number of images that the overall image C1 can contain, as described above.

The third processing section 33 is formed of one or more CPUs. The third processing section 33 reads the third program P3 from the third storage 32. The third processing section 33 functions as a processing controller 331 by executing the third program P3. The processing controller 331 may be achieved by a circuit, such as a DSP, an ASIC, a PLD, and an FPGA.

The processing controller 331 controls a variety of processes. The processing controller 331 counts the number of image signals received by the second communication section 31. The processing controller 331 generates the signal number information F1 based on the result of the counting operation. The processing controller 331 updates the signal number information F1 in accordance with a change in the number of image signals received by the second communication section 31. The processing controller 331 further generates overall image data G1 representing the overall image C1. The processing controller 331 generates the overall image data G1 based, for example, on the image signals received by the second communication section 31.

The projection section 34 projects the overall image C1 based on the overall image data G1 onto the display surface 4. The projection section 34 includes a driver 341, a light source 342, liquid crystal light valves 343, and a projection system 344. The liquid crystal light valves 343 include a red liquid crystal light valve 343R, a green liquid crystal light valve 343G, and a blue liquid crystal light valve 343B.

The driver 341 generates a voltage signal H1 based on the overall image data G1. The driver 341 drives the liquid crystal light valves 343 by applying the voltage signal H1 to the liquid crystal light valves 343.

The light source 342 is an LED (light emitting diode). The light source 342 is not limited to an LED and may, for example, be a xenon lamp, an ultrahigh-pressure mercury lamp, or a laser light source. The light source 342 outputs visible light.

The light outputted from the light source 342 enters an optical integration system that is not shown. The optical integration system reduces variation in the luminance distribution of the light incident thereon.

The liquid crystal light valves 343 are an example of a light modulator. The liquid crystal light valves 343 each have a rectangular pixel area 343a. The pixel area 343a includes a plurality of pixels 343p arranged in a matrix.

When the driver 341 applies the voltage signal H1 to each of the pixels 343p, the optical transmittance of each of the pixels 343p is changed based on the voltage signal Hl. The light outputted from the light source 342 is modulated when passing through the pixel areas 343a to generate the overall image C1. The overall image C1 is projected via the projection system 344.

### A7: Description of Action

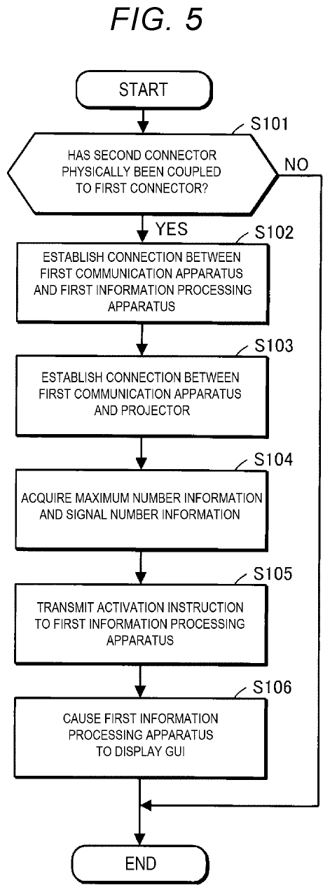

The action of the display system 1000 will be described primarily in terms of the action of the first communication apparatus 21. FIG. 5 is a flowchart for describing the action in which the first communication apparatus 21 causes the first information processing apparatus 11 to display the GUI 5.

A user first physically couples the second connector 211 of the first communication apparatus 21 to the first connector 112 of the first information processing apparatus 11.

When the second connector 211 is physically coupled to the first connector 112, an electrical signal is supplied to the second connector 211 via the first connector 112. When the electrical signal is supplied to the second connector 211 via the first connector 112, the connection controller 201 detects the physical coupling between the second connector 211 and the first connector 112 in step S101.

A method for detecting the physical coupling between the second connector 211 and the first connector 112 is not limited to the method described above and may, for example, be a detection method using a switch that closes when the second connector 211 is physically coupled to the first connector 112.

Upon detection of the physical coupling between the second connector 211 and the first connector 112, the connection controller 201 establishes the connection between the first communication apparatus 21 and the first information processing apparatus 11 in step S102.

Upon establishment of the connection between the first communication apparatus 21 and the first information processing apparatus 11, the connection controller 201 establishes the connection between the first communication apparatus 21 and the projector 3 in step S103.

When the connection controller 201 establishes the connection between the first communication apparatus 21 and the projector 3, the acquisition section 202 acquires the maximum number information E1 and the signal number information F1 from the projector 3 in step S104.

For example, in step S104, the acquisition section 202 first transmits first request information for requesting the maximum number information E1 and the signal number information F1 to the projector 3 via the first communication section 212. When the processing controller 331 of the projector 3 receives the first request information via the second communication section 31, the processing controller 331 reads the maximum number information E1 from the third storage 32. The processing controller 331 subsequently generates the signal number information F1 representing the number of image signals being received by the second communication section 31. The processing controller 331 may generate the signal number information F1 before reading the maximum number information E1. The processing controller 331 transmits the maximum number information E1 and the signal number information F1 to the first communication apparatus 21 via the second communication section 31. The acquisition section 202 of the first communication apparatus 21 acquires the maximum number information E1 and the signal number information F1 via the first communication section 212.

The processing controller 331 of the projector 3 may transmit the maximum number information E1 and the signal number information F1 to the first communication apparatus 21 via the second communication section 31 when the connection between the first communication apparatus 21 and the projector 3 is established. In this case, the acquisition section 202 of the first communication apparatus 21 acquires the maximum number information E1 and the signal number information F1 via the first communication section 212 without transmitting the first request information.

When the acquisition section 202 acquires the maximum number information E1 and the signal number information F1, the display controller 203 transmits in step S105 an activation instruction for activating the first program P1 to the first information processing apparatus 11 via the second connector 211. When the first processing section 114 of the first information processing apparatus 11 receives the activation instruction via the first connector 112, the first processing section 114 reads the first program P1 from the first storage 113. Subsequently, the first processing section 114 functions as the operation controller 101 by executing the first program P1.

The timing of the execution of step S105 is not limited to the timing after the execution of step S104. Step S105 only needs to be executed during the period from the timing after the completion of step S102 to the timing before the execution of step S106, which will be described later.

Subsequently, in step S106, the display controller 203 causes the first information processing apparatus 11 to display the GUI 5 based on the maximum number information E1 and the signal number information F1.

For example, in step S106, the display controller 203 causes the first information processing apparatus 11 to display the GUI 5 by transmitting the maximum number information E1 and the signal number information F1 to the first information processing apparatus 11 via the second connector 211.

The operation controller 101 of the first information processing apparatus 11 receives the maximum number information E1 and the signal number information F1 via the first connector 112. The operation controller 101 determines the aspect of the GUI 5 based on whether the maximum number indicated by the maximum number information E1 is greater than the number indicated by the signal number information F1 or vice versa. The aspect of the GUI 5 in the case where the maximum number indicated by the maximum number information E1 is greater than the number indicated by the signal number information F1 differs from the aspect of the GUI 5 in a case where the maximum number indicated by the maximum number information E1 is equal to the number indicated by the signal number information F1. The operation controller 101 causes the first display section 111 to display the GUI 5 having the determined aspect.

### A8: Example of Aspect of GUI 5

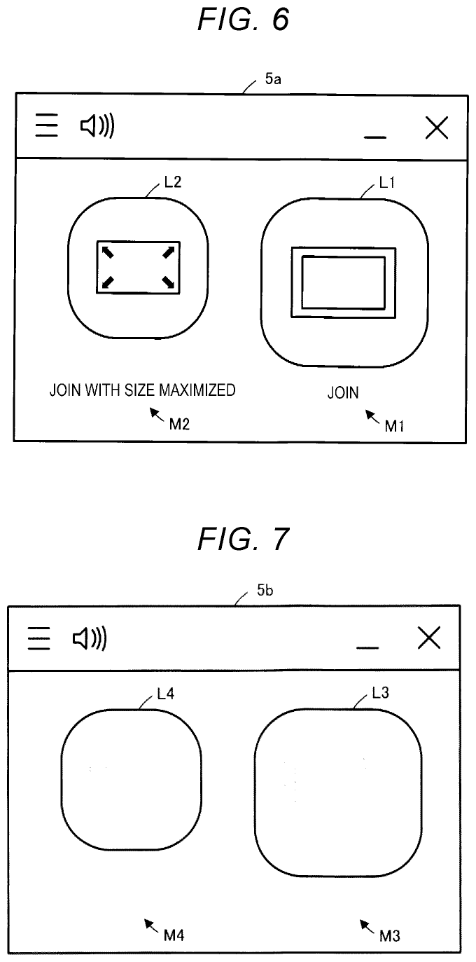

FIG. 6 shows an example of the aspect of the GUI 5 in the case where the maximum number indicated by the maximum number information E1 is greater than the number indicated by the signal number information F1. When the maximum number indicated by the maximum number information E1 is greater than the number indicated by the signal number information F1, the projector 3 can newly receive an image signal.

FIG. 6 shows a GUI 5a as an example of the aspect of the GUI 5. The GUI 5a shows buttons L1 and L2 and letter strings M1 and M2.

The button L1 is used to transmit the image signal B1 to the projector 3. Transmitting the image signal B1 to the projector 3 means joining a group of apparatuses that transmit image signals to the projector 3. The button L1 is further used to place the image A1 based on the image signal B1 in one of the first area C11 and the second area C12 in the overall image C1. The aspect of the button L1 is not limited to the aspect shown in FIG. 6 and can be changed.

The letter string M1 is paired with the button L1. The letter string M1 indicates that the button L1 is used to transmit the image signal B1 to the projector 3. The letter string M1 is not limited to “join” and can be changed. The letter string M1 may be omitted.

The button L2 is used to transmit the image signal B1 to the projector 3. The button L2 is further used to place the image A1 based on the image signal B1 across the overall image C1. The aspect of the button L2 is not limited to the aspect shown in FIG. 6 and can be changed. The button L2 may be omitted.

The letter string M2 is paired with the button L2. The letter string M2 indicates that the button L2 is used to transmit the image signal B1 to the projector 3, and that the image A1 based on the image signal B1 is placed across the overall image C1. The letter string M2 is not limited to “join with size maximized” and can be changed. The letter string M2 may be omitted along with the button L2. The letter string M2 may be omitted in the situation in which the button L2 is provided.

FIG. 7 shows an example of the aspect of the GUI 5 in the case where the maximum number indicated by the maximum number information E1 is equal to the number indicated by the signal number information F1. When the maximum number indicated by the maximum number information E1 is equal to the number indicated by the signal number information F1, the projector 3 cannot newly receive an image signal.

FIG. 7 shows a GUI 5b as an example of the aspect of the GUI 5. The GUI 5b shows buttons L3 and L4 and letter strings M3 and M4.

The button L3 is the button L1 that is grayed out. The button L3 indicates that the image signal B1 cannot be transmitted to the projector 3. The aspect of the button L3 is not limited to the aspect shown in FIG. 7 and can be changed.

The letter string M3 is paired with the button L3. The letter string M3 is the letter string M1 having been grayed out. The letter string M3 indicates that the image signal B1 cannot be transmitted to the projector 3. The aspect of the letter string M3 is not limited to the aspect shown in FIG. 7 and can be changed. The letter string M3 may be omitted.

The button L4 is the button L2 having been grayed out. The button L4 indicates that the image signal B1 cannot be transmitted to the projector 3. The aspect of the button L4 is not limited to the aspect shown in FIG. 7 and can be changed. The button L4 may be omitted.

The letter string M4 is paired with the button L4. The letter string M4 is the letter string M2 having been grayed out. The letter string M4 indicates that the image signal B1 cannot be transmitted to the projector 3. The aspect of the letter string M4 is not limited to the aspect shown in FIG. 7 and can be changed. The letter string M4 may be omitted along with the button L4. The letter string M4 may be omitted in the situation in which the button L4 is provided.

The aspect of the GUI 5 is changed in accordance with whether the maximum number indicated by the maximum number information E1 is greater than the number indicated by the signal number information F1 or vice versa, as shown in FIGS. 6 and 7. That is, the display controller 203 transmits the maximum number information E1 and the signal number information F1 to the first information processing apparatus 11 to cause the first information processing apparatus 11 to change the aspect of the GUI 5 in accordance with whether the maximum number indicated by the maximum number information E1 is greater than the number indicated by the signal number information F1 or vice versa. The GUI 5 indicates whether the image signal B1 can be transmitted or not from the first information processing apparatus 11 to the projector 3.

### A9: Transmission of Image Signal B1 to Projector 3

When the button L1 shown in FIG. 6 is clicked or flicked, the operation controller 101 of the first information processing apparatus 11 reads the first image data D1 from the first storage 113. The operation controller 101 subsequently causes the first display section 111 to display the image A1 based on the first image data D1. The operation controller 101 subsequently generates the image signal B1 based on the first image data D1. The operation controller 101 subsequently transmits the image signal B1 and a division instruction corresponding to the button L1 to the first communication apparatus 21 via the first connector 112. The division instruction is an instruction for displaying the image A1 based on the image signal B1 in the first area C11 or the second area C12.

The communication controller 204 of the first communication apparatus 21 receives the image signal B1 and the division instruction via the second connector 211. The communication controller 204 subsequently transmits the image signal B1 and the division instruction to the projector 3 via the first communication section 212.

The processing controller 331 of the projector 3 receives the image signal B1 and the division instruction via the second communication section 31. The processing controller 331 subsequently generates the overall image data G1, which represents the overall image C1, based on the image signal B1 and the division instruction.

For example, when the processing controller 331 newly receives the image signal B1 and the division instruction in a situation in which the processing controller 331 receives no image signal, the processing controller 331 generates based on the image signal B1 the overall image data G1 representing the overall image C1 with the image A1 located in the first area C11. When the processing controller 331 newly receives the image signal B1 and the division instruction in the situation in which the processing controller 331 receives no image signal, the processing controller 331 may generate based on the image signal B1 the overall image data G1 representing the overall image C1 with the image A1 located in the second area C12.

When the processing controller 331 newly receives the image signal B1 and the division instruction in a situation in which the processing controller 331 receives only one image signal, the processing controller 331 generates based on the image signal B1 the overall image data G1 representing the overall image C1 with the image A1 located in the first area C11. In this case, the image based on the one image signal is located in the second area C12.

When the processing controller 331 newly receives the image signal B1 and the division instruction in the situation in which the processing controller 331 receives only one image signal, the processing controller 331 may generate based on the image signal B1 the overall image data G1 representing the overall image C1 with the image A1 located in the second area C12. In this case, the image based on the one image signal is located in the first area C11.

Upon generation of the overall image data G1, the processing controller 331 provides the projection section 34 with the overall image data G1 to cause the projection section 34 to project the overall image C1 based on the overall image data G1 onto the display surface 4.

When the button L2 shown in FIG. 6 is clicked or flicked, the operation controller 101 of the first information processing apparatus 11 reads the first image data D1 from the first storage 113. The operation controller 101 subsequently causes the first display section 111 to display the image A1 based on the first image data D1. The operation controller 101 subsequently generates the image signal B1 based on the first image data D1. The operation controller 101 subsequently transmits the image signal B1 and a maximization instruction corresponding to the button L2 to the first communication apparatus 21 via the first connector 112. The maximization instruction is an instruction for displaying the image A1 based on the image signal B1 across the overall image C1.

The communication controller 204 of the first communication apparatus 21 receives the image signal B1 and the maximization instruction via the second connector 211. The communication controller 204 subsequently transmits the image signal B1 and the maximization instruction to the projector 3 via the first communication section 212.

The processing controller 331 of the projector 3 receives the image signal B1 and the maximization instruction via the second communication section 31. The processing controller 331 subsequently generates the overall image data G1, which represents the overall image C1, based on the image signal B1 and the maximization instruction.

For example, when the processing controller 331 newly receives the image signal B1 and the maximization instruction, the processing controller 331 generates based on the image signal B1 the overall image data G1 representing the overall image C1 with the image A1 located across the overall image C1.

Upon generation of the overall image data G1, the processing controller 331 provides the projection section 34 with the overall image data G1 to cause the projection section 34 to project the overall image C1 based on the overall image data G1 onto the display surface 4.

### A10: Change in Aspect of GUI 5 in Accordance with Transmission of Image Signal B1

The operation controller 101 of the first information processing apparatus 11 changes the aspect of the GUI 5 in accordance with the transmission of the image signal B1.

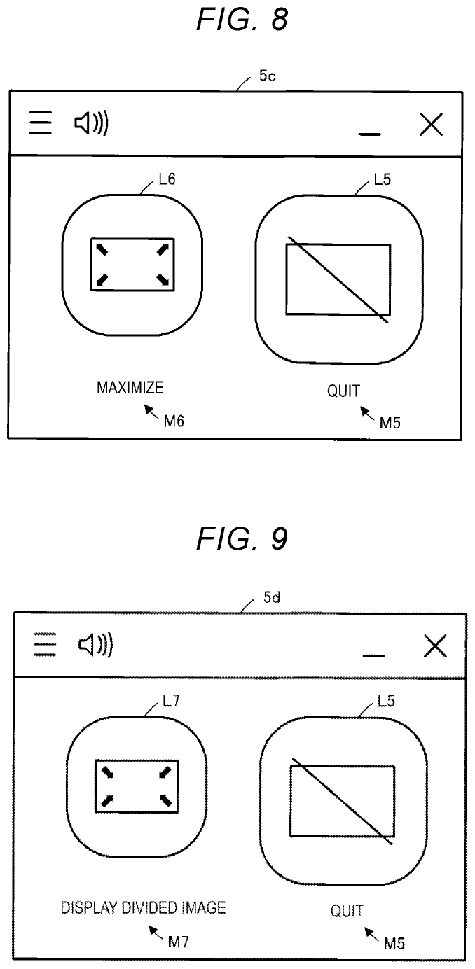

FIG. 8 shows an example of the aspect of the GUI 5 in the situation in which the image signal B1 is transmitted when the button L1 shown in FIG. 6 is clicked or flicked. FIG. 8 shows a GUI 5c as an example of the aspect of the GUI 5. The GUI 5c shows buttons L5 and L6 and letter strings M5 and M6.

The button L5 is used to stop transmitting the image signal B1. Stopping the transmission of the image signal B1 means quitting the group of apparatuses that transmit image signals to the projector 3. The aspect of the button L5 is not limited to the aspect shown in FIG. 8 and can be changed.

The letter string M5 is paired with the button L5. The letter string M5 indicates that the button L5 is used to stop transmitting the image signal B1. The letter string M5 is not limited to “quit” and can be changed. The letter string M5 may be omitted.

The button L6 is used to display the image A1 across the overall image C1. The aspect of the button L6 is not limited to the aspect shown in FIG. 8 and can be changed. The button L6 may be omitted.

The letter string M6 is paired with the button L6. The letter string M6 indicates that the button L6 is used to display the image A1 across the overall image C1. The letter string M6 is not limited to “maximize” and can be changed. The letter string M6 may be omitted along with the button L6. The letter string M6 may be omitted in the situation in which the button L6 is present.

For example, when the button L5 is clicked or flicked, the operation controller 101 stops the transmission of the image signal B1 to the projector 3 via the first communication apparatus 21. Furthermore, the operation controller 101 changes the aspect of the GUI 5 from the aspect of the GUI 5c shown in FIG. 8 to the aspect of the GUI 5a shown in FIG. 6.

For example, when the button L6 is clicked or flicked, the maximization instruction is transmitted from the operation controller 101 to the projector 3 via the first communication apparatus 21. When the processing controller 331 of the projector 3 receives the maximization instruction, the processing controller 331 generates the overall image data G1 representing the overall image C1 in which the image A1 is located thereacross. Furthermore, the operation controller 101 changes the aspect of the GUI 5 from the aspect of the GUI 5c shown in FIG. 8 to the aspect of the GUI 5d shown in FIG. 9. The aspect of the GUI 5d shown in FIG. 9 is also achieved in the situation in which the image signal B1 is transmitted when the button L2 shown in FIG. 6 is clicked or flicked.

FIG. 9 shows the GUI 5d as an example of the aspect of the GUI 5. The GUI 5d shows the button L5, a button L7, the letter string M5, and a letter string M7.

The button L7 is used to display the image A1 in the first area C11 or the second area C12. The aspect of the button L7 is not limited to the aspect shown in FIG. 9 and can be changed. The button L7 may be omitted.

The letter string M7 is paired with the button L7. The letter string M7 indicates that the button L7 is used to display the image A1 in the first area C11. The letter string M7 is not limited to “display divided images” and can be changed. The letter string M7 may be omitted along with the button L7. The letter string M7 may be omitted in the situation in which the button L7 is present.

For example, when the button L7 is clicked or flicked, the division instruction is transmitted from the operation controller 101 to the projector 3 via the first communication apparatus 21.

When the processing controller 331 of the projector 3 receives the division instruction in the situation in which the processing controller 331 receives only the image signal B1, the processing controller 331 generates the overall image data G1 representing the overall image C1 with the image A1 located in the first area C11. When the processing controller 331 of the projector 3 receives the division instruction in the situation in which the processing controller 331 receives only the image signal B1, the processing controller 331 may generate the overall image data G1 representing the overall image C1 with the image A1 located in the second area C12.

When the processing controller 331 of the projector 3 receives the division instruction in a situation in which the processing controller 331 receives one image signal in addition to the image signal B1, the processing controller 331 generates the overall image data G1 representing the overall image C1 with the image A1 located in the first area C11. In this case, the image based on the one image signal is located in the second area C12.

When the processing controller 331 of the projector 3 receives the division instruction in the situation in which the processing controller 331 receives one image signal in addition to the image signal B1, the processing controller 331 may generate the overall image data G1 representing the overall image C1 with the image A1 located in the second area C12. In this case, the image based on the one image signal is located in the first area C11.

### A11: Overview of First Embodiment

The method for operating the first communication apparatus 21 according to the present embodiment described above, and the first communication apparatus 21 include the following aspects.

The connection controller 201 establishes the connection between the first communication apparatus 21 and the projector 3 in response to the establishment of the connection between the first communication apparatus 21 and the first information processing apparatus 11. The acquisition section 202 acquires the maximum number information E1 and the signal number information F1 from the projector 3 in response to the establishment of the connection between the first communication apparatus 21 and the projector 3. The maximum number information E1 represents the maximum number of images that the overall image C1 can contain. The overall image C1 is an image that the projector 3 displays on the display surface 4. The signal number information F1 represents the number of image signals that the projector 3 receives. The number of image signals that the projector 3 receives is equal to the number of images that the overall image C1 can contain. The display controller 203 causes the first information processing apparatus 11 to display the GUI 5 based on the maximum number information E1 and the signal number information F1.

According to the aspect described above, the user can obtain information on an image displayed by the display apparatus by performing an operation of establishing the connection between the first communication apparatus 21 and the first information processing apparatus 11. The user can thus obtain information on an image displayed by the display apparatus in fewer steps. An example of the operation of establishing the connection between the first communication apparatus 21 and the first information processing apparatus is the operation of physically coupling the first communication apparatus 21 to the first information processing apparatus 11. The information on an image displayed by the display apparatus is in the present aspect the maximum number information E1 and the signal number information F1.

The first communication apparatus 21 can obtain information on an image displayed by the display apparatus irrespective of the status of the transmission of the image signal B1 from the first communication apparatus 21 to the projector 3.

The GUI 5 is an image based on whether the maximum number indicated by the maximum number information E1 is greater than the number indicated by the signal number information F1 or vice versa. According to the aspect described above, the user can check whether the maximum number indicated by the maximum number information E1 is greater than the number indicated by the signal number information F1 or vice versa by checking the GUI 5. When the maximum number indicated by the maximum number information E1 is greater than the number indicated by the signal number information F1, the projector 3 can newly receive an image signal. When the maximum number indicated by the maximum number information E1 is equal to the number indicated by the signal number information F1, the projector 3 cannot newly receive an image signal. The user can therefore check whether the projector 3 can newly receive or not an image signal by checking the GUI 5. The user can further check whether an image signal can be newly received or not by the projector 3 by checking the GUI 5.

The display controller 203 causes the first information processing apparatus 11 to change the aspect of the GUI 5 in accordance with whether the maximum number indicated by the maximum number information E1 is greater than the number indicated by the signal number information F1 or vice versa. According to the aspect described above, the user can check whether the projector 3 can newly receive or not an image signal by checking the aspect of the GUI 5. The user can further check whether an image signal can be newly received or not by the projector 3 by checking the aspect of the GUI 5.

The GUI 5 is used as an image based on the maximum number information E1 and the signal number information F1. According to the aspect described above, the GUI 5 can also be used as an image based on the maximum number information E1 and the signal number information F1.

The GUI 5 indicates whether the image signal B1 can be transmitted or not from the first information processing apparatus 11 to the projector 3. According to the aspect described above, the user can check whether the image signal B1 can be transmitted or not from the first information processing apparatus 11 to the projector 3 by checking the aspect of the GUI 5.

### B: Variations

The aspects of variations of the embodiment presented above will be presented below by way of example. Two or more aspects arbitrarily selected from those presented below byway of example may be combined with each other as appropriate to the extent that the aspects to be combined with each other do not contradict each other.

### B1: First Variation

In the first embodiment, the maximum number information E1 may represent the maximum number of image signals receivable by the projector 3 in place of the maximum number of images that the overall image C1 can contain. The connection controller 201 establishes the connection between the first communication apparatus 21 and the projector 3 when the connection between the first communication apparatus 21 and the first information processing apparatus 11 is established. The acquisition section 202 acquires the maximum number information E1, which represents the maximum number of image signals receivable by the projector 3, and the signal number information F1 from the projector 3 in response to the establishment of the connection between the first communication apparatus 21 and the projector 3. The display controller 203 causes the first information processing apparatus 11 to display the GUI 5 based on the maximum number information E1 and the signal number information F1.

Also in the first variation, the user can obtain information on an image displayed by the display apparatus by performing an operation of establishing the connection between the first communication apparatus 21 and the first information processing apparatus 11. The user can thus obtain information on an image displayed by the display apparatus in fewer steps.

Also in the first variation, when the maximum number indicated by the maximum number information E1 is greater than the number indicated by the signal number information F1, the projector 3 can newly receive an image signal. When the maximum number indicated by the maximum number information E1 is equal to the number indicated by the signal number information F1, the projector 3 cannot newly receive an image signal. The user can therefore check whether the projector 3 can newly receive or not an image signal by checking the GUI 5. The user can further check whether an image signal can be newly received or not by the projector 3 by checking the GUI 5.

### B2: Second Variation

In the first embodiment and the first variation, the communication controller 204 transmits the image signal B1 outputted by the first information processing apparatus 11 to the projector 3 when the maximum number indicated by the maximum number information E1 is greater than the number indicated by the signal number information F1. The communication controller 204 may transmit the image signal B1 outputted by the first information processing apparatus 11 to the projector 3 by controlling the first information processing apparatus 11 when the maximum number indicated by the maximum number information E1 is greater than the number indicated by the signal number information F1.

For example, when the maximum number indicated by the maximum number information E1 is greater than the number indicated by the signal number information F1, the communication controller 204 transmits second request information for requesting the image signal B1 to the first information processing apparatus 11 via the second connector 211.

When the operation controller 101 of the first information processing apparatus 11 receives the second request information via the first connector 112, the operation controller 101 reads the first image data D1 from the first storage 113. The operation controller 101 subsequently causes the first display section 111 to display the image A1 based on the first image data D1. The operation controller 101 subsequently generates the image signal B1 based on the first image data D1. The operation controller 101 subsequently transmits the image signal B1 and the division instruction to the first communication apparatus 21 via the first connector 112.

The communication controller 204 of the first communication apparatus 21 receives the image signal B1 and the division instruction via the second connector 211. The communication controller 204 subsequently transmits the image signal B1 and the division instruction to the projector 3 via the first communication section 212.

When the projector 3 receives the image signal B1 and the division instruction, the projector 3 projects the overall image C1 containing the image A1 onto the display surface 4. The method for projecting the overall image C1 onto the display surface 4 in response to the receipt of the image signal B1 and the division instruction is as described above.

Instead of transmitting the image signal B1 and the division instruction in response to the second request information, the operation controller 101 may transmit the image signal B1 and the maximization instruction in response to the second request information. In this case, the projector 3 is provided with the maximization instruction in place of the division instruction via the first communication apparatus 21. The method for projecting the overall image C1 onto the display surface 4 in response to the receipt of the image signal B1 and the maximization instruction is as described above.

According to the second variation, the operation controller 101 transmits the image signal B1 from the first information processing apparatus 11 to the projector 3 when triggered by the connection between the first communication apparatus 21 and the first information processing apparatus 11 is established. The user can therefore cause the projector 3 to project the overall image C1 containing the image A1 based on the image signal B1 simply by physically coupling the first communication apparatus 21 to the first information processing apparatus 11.

### B3: Third Variation

The number of image signals provided to the projector 3 may change over time. For example, there is a conceivable situation in which the image signals B2 and B3 are provided to the projector 3 at a first timing and only the image signal B2 is provided to the projector 3 at a second timing later than the first timing. In this situation, the projector 3 cannot newly receive the image signal B1 at the first timing. The projector 3 can, however, newly receive the image signal B1 at the second timing.

In the third variation, the acquisition section 202 receives from the projector 3 third information representing the number of image signals received by the projector 3 after causing the first information processing apparatus 11 to display the GUI 5 in the first embodiment and the first and second variations. The display controller 203 causes the first information processing apparatus 11 to update the GUI 5 based on the maximum number information E1 and the third information.

For example, the acquisition section 202 acquires the third information from the projector 3 by requesting the third information from the projector 3 via the first communication section 212 after the display controller 203 causes the first information processing apparatus 11 to display the GUI 5. In this case, when the processing controller 331 of the projector 3 receives the request for the third information, the processing controller 331 updates the signal number information F1 based on the number of image signals received by the second communication section 31. The processing controller 331 transmits the updated signal number information F1 as the third information to the first communication apparatus 21 via the second communication section 31. The acquisition section 202 of the first communication apparatus 21 receives the updated signal number information F1 as the third information.

The display controller 203 causes the first information processing apparatus 11 to update the GUI 5, for example, by transmitting the maximum number information E1 and the third information to the first information processing apparatus 11 via the second connector 211.

The operation controller 101 of the first information processing apparatus 11 receives the maximum number information E1 and the third information via the first connector 112. The operation controller 101 determines the aspect of the GUI 5 based on whether the maximum number indicated by the maximum number information E1 is greater than the number indicated by the third information or vice versa. The aspect of the GUI 5 in the case where the maximum number indicated by the maximum number information E1 is greater than the number indicated by the third information differs from the aspect of the GUI 5 in the case where the maximum number indicated by the maximum number information E1 is equal to the number indicated by the third information.

An example of the aspect of the GUI 5 in the case where the maximum number indicated by the maximum number information E1 is greater than the number indicated by the third information is the aspect of the GUI 5a shown in FIG. 6. An example of the aspect of the GUI 5 in the case where the maximum number indicated by the maximum number information E1 is equal to the number indicated by the third information is the aspect of the GUI 5b shown in FIG. 7. The operation controller 101 updates the aspect of the GUI 5 to the determined aspect.

According to the third variation, the aspect of the GUI 5 can be updated in accordance with a change in the number of image signals provided to the projector 3. The user can therefore check the latest information on whether the projector 3 can newly receive or not an image signal by checking the GUI 5. The user can further check the latest information on whether an image signal can be newly received or not by the projector 3 by checking the GUI 5.

### B4: Fourth Variation

In the first embodiment and the first to third variations, the display controller 203 of the first communication apparatus 21 may generate GUI information representing the GUI 5 based on the maximum number information E1 and the signal number information F1.

The relationship of the aspect of the GUI 5 indicated by the GUI information with the maximum number information E1 and the signal number information F1 is the same as the relationship of the aspect of the GUI 5 determined by the operation controller 101 of the first information processing apparatus 11 with the maximum number information E1 and the signal number information F1.

The display controller 203 may transmit the GUI information to the first information processing apparatus 11 to cause the first information processing apparatus 11 to display the GUI 5. In this case, the operation controller 101 of the first information processing apparatus 11 causes the first display section 111 to display the GUI 5 indicated by the GUI information.

According to the fourth variation, the display controller 203 of the first communication apparatus 21 determines the aspect of the GUI 5. The load on the first information processing apparatus 11 can therefore be reduced as compared with the load in the first embodiment and the first to third variations. The first program P1 in the first information processing apparatus 11 can also be simplified.

### B5: Fifth Variation

In the first embodiment and the first to fourth variants, the second image is not limited to the GUI 5. The second image may be a message image showing a letter string. For example, when the maximum number indicated by the maximum number information E1 is greater than the number indicated by the signal number information F1, the second image may be a message image showing a letter string stating “The projector can newly receive an image signal.” When the maximum number indicated by the maximum number information E1 is equal to the number indicated by the signal number information F1, the second image may be a message image showing a letter string stating “The projector cannot newly receive an image signal.” The letter strings described above can be changed as appropriate.

### B6: Sixth Variation

In the first embodiment and the first to fifth variations, the second information processing apparatus 12 and the second communication apparatus 22 may or may not perform the same operations as those performed by the first information processing apparatus 11 and the first communication apparatus 21.

When the second information processing apparatus 12 and the second communication apparatus 22 do not perform the same operations as those performed by the first information processing apparatus 11 and the first communication apparatus 21, the user needs to perform first to third operations to obtain information on the image displayed by the display apparatus. The first operation is the operation that causes the second information processing apparatus 12 to activate the first program P1. The second operation is the operation of physically coupling the second communication apparatus 22 to the second information processing apparatus 12. The third operation is the operation of establishing the connection between the second communication apparatus 22 and the projector 3.

When the second information processing apparatus 12 and the second communication apparatus 22 perform the same operations as those performed by the first information processing apparatus 11 and the first communication apparatus 21, the first and third operations are automatically performed in response to the second operation performed by the user. The user can thus obtain information on an image displayed by the display apparatus in fewer steps.

In the first embodiment and the first to fifth variations, the third information processing apparatus 13 and the third communication apparatus 23 may or may not perform the same operations as those performed by the first information processing apparatus 11 and the first communication apparatus 21.

### B7: Seventh Variation

In the first embodiment and the first to sixth variations, the second communication section 31 may not be built in the projector 3 and may be separate from the projector 3. In the first embodiment and the first to sixth variations, the second communication section 31 or the processing controller 331 may not be built in the projector 3 and may be separate from the projector 3.

### B8: Eighth Variation

The liquid crystal light valves 343 are used as an example of the light modulator. The light modulator is, however, not limited to liquid crystal light valves and can be changed as appropriate. For example, the light modulator may be configured to use one digital mirror device or may be configured based on another scheme. In place of a liquid crystal panel or a DMD, a configuration capable of modulating the light outputted from the light source 342 can be adopted as the light modulator.

What is claimed is:

1. A method for operating a communication apparatus, the method comprising:
establishing connection, in response to establishment of connection between the communication apparatus and an information processing apparatus, between the communication apparatus and a display apparatus that displays a first image on a display surface;
causing the communication apparatus to acquire from the display apparatus first information representing a maximum number of one or more image signals used to generate the first image and second information representing a number of image signals being received by the display apparatus from one or more other information processing apparatuses different from the information processing apparatus in response to the establishment of the connection between the communication apparatus and the display apparatus; and
causing the communication apparatus to cause the information processing apparatus to display a second image based on the first information and the second information.

2. The operation method according to claim 1,
wherein the second image is an image based on a result of comparison between magnitude of the maximum number and magnitude of the number of image signals being received.

3. The operation method according to claim 2,
wherein the information processing apparatus is caused to change an aspect of the second image in accordance with the result of the comparison.

4. The operation method according to claim 1, further comprising:
causing the information processing apparatus to output a first image signal, and
transmitting, when the maximum number is greater than the number of image signals being received, the first image signal to the display apparatus.

5. The operation method according to claim 4,
wherein the second image is a graphical user interface.

6. The operation method according to claim 5,
wherein the graphical user interface indicates whether the first image signal is allowed to be transmitted or not from the information processing apparatus to the display apparatus.

7. A communication apparatus comprising
one or more processors programmed to
establish connection, in response to establishment of connection between the communication apparatus and an information processing apparatus, between the communication apparatus and a display apparatus that displays a first image on a display surface,
acquire from the display apparatus first information representing a maximum number of one or more image signals used to generate the first image and second information representing a number of image signals being received by the display apparatus from one or more other information processing apparatuses different from the information processing apparatus in response to the establishment of the connection between the communication apparatus and the display apparatus, and
cause the information processing apparatus to display a second image based on the first information and the second information.

8. A method for operating a communication apparatus, the method comprising:
establishing connection, when connection between the communication apparatus and an information processing apparatus is established, between the communication apparatus and a display apparatus that displays a first image on a display surface;
causing the communication apparatus to acquire from the display apparatus first information representing a maximum number of one or more image signals used to generate the first image and second information representing a number of image signals being received by the display apparatus from one or more other information processing apparatuses different from the information processing apparatus in response to the establishment of the connection between the communication apparatus and the display apparatus; and
causing the communication apparatus to cause the information processing apparatus to display a second image based on the first information and the second information.

9. The operation method according to claim 8,
wherein the second image is an image based on a result of comparison between magnitude of the maximum number and magnitude of the number of image signals being received.

10. The operation method according to claim 9,
wherein the information processing apparatus is caused to change an aspect of the second image in accordance with the result of the comparison.

11. The operation method according to claim 8, further comprising:
causing the information processing apparatus outputs a first image signal, and
transmitting, when the maximum number is greater than the number of image signals being received, the first image signal to the display apparatus.

12. The operation method according to claim 11,
wherein the second image is a graphical user interface.

13. The operation method according to claim 12,
wherein the graphical user interface indicates whether the first image signal is allowed to be transmitted or not from the information processing apparatus to the display apparatus.
